(19) United States
(12) Patent Application Publication
(10) Pub. No.: US 2008/0094659 A1
(43) Pub. Date: Apr. 24, 2008

(54) Print setting means, print setting apparatus, and printing apparatus

(75) Inventor: Shogo Ito, Kagoshima-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/973,105

(22) Filed: Oct. 4, 2007

(30) Foreign Application Priority Data
Oct. 5, 2006 (JP) 2006-273854

(51) Int. Cl. G06K 1/00

(52) U.S. Cl. 358/1.15

(57) ABSTRACT

A print setting means 50 has a first selection unit 52 that selects a first setting value out of a plurality of first setting value candidates related to printing and further has a second selection unit 62 that selects a second setting value out of listed second setting value candidates related to printing, where the second setting value candidates are different from the first setting value candidates and are listed depending on the first setting value. In the configuration of the print setting means 50 described above, the first setting value is notified to a printing apparatus 20 at each time of selection made by the first selection unit 52, whereas, at each time of selection made by the second selection unit 62, the content of setting is retained and thereafter notified to the printing apparatus 20 in response to instructions.

The entire disclosure of Japanese Patent Application No. 2006-273854, filed Oct. 5, 2006 is expressly incorporated by reference herein.

### BACKGROUND OF THE INVENTION

1. Field of the Invention

The present invention relates to a print setting means, a print setting apparatus, and a printing apparatus.

2. Related-Art Invention

A printing system that allows a client side to make the print-related setting of a printing apparatus that is connected to a network is known. As described in Patent Document 1 listed below, such a printing system allows a user to make print-related setting as follows. A client browser makes a request for an HTML page to an HTTP server of a printing apparatus. In response to the request, the HTTP server provides the HTTP page to the client. The HTTP page is displayed on the client browser. Then, the user manipulates the displayed HTML page to make the print-related setting.

[Patent Document 1] Japanese Unexamined Patent Application Publication No. 2001-142657.

However, a user could sometimes experience setting restrictions in the course of print-related setting. For example, as a result of the selection of a certain setting value for one print setting item, setting values available for other print setting item may be restricted in some cases. In order to display an HTML page that reflects such setting restrictions, it is necessary to update the HTML page at each time of the selection of a certain setting value. For this purpose, it is necessary to notify the HTTP server of the selection of a certain setting value for a certain print setting item. Conventionally, in order to provide such a notification, the HTTP server is informed of each act of selection for all selection items in an HTML page, which inevitably increases the amount of data sent via a network. Therefore, a user has to wait until data transmission/reception to/from the HTTP server and a series of client-side data processing are completed, which take a substantially long time.

### SUMMARY OF THE INVENTION

In order to provide a solution to the problem described above, a print setting method according to the invention is characterized by displaying an information screen that is sent from a printing apparatus connected to a network so as to make the setting of the printing apparatus. The print setting method according to the invention is further characterized by including: a first print setting selecting step of selecting a first setting value out of a plurality of first setting value candidates related to printing; a second print setting selecting step of selecting a second setting value out of second setting value candidates related to printing, the second setting value candidates being different from the first setting value candidates, the second setting value candidates being listed depending on the first setting value; a first notifying step of notifying information related to the first setting value and a request for updating the information screen to the printing apparatus at each time of selection of the first setting value; a retaining section that retains information related to the second setting value on the information screen in an invisible state at each time of selection of the second setting value; an instructing section that instructs that a notification of information that is different from information indicated by the first setting value candidates and the second setting value candidates should be sent to the printing apparatus; and a second notifying step of notifying, in response to instructions given by the instructing section, information related to the second setting value that is retained at the retaining section and a request for transition to a next information screen that is to be displayed subsequently.

According to the invention, in a case where a first setting value is selected out of a plurality of setting value candidates of the first setting value candidates provided for making print-related setting, information related to the first setting value and a request for updating an information screen are notified at each time of selection thereof. On the other hand, in a case where a second setting value is selected out of second setting value candidates provided for making print-related setting, where the second setting value candidates are different from the first setting value candidates and are listed depending on the first setting value, information related to the selected second setting value is retained. Then, information related to the second setting value and a request for transition to a next information screen that is to be displayed subsequently are notified to a printing apparatus upon reception of instructions for sending a notification to the printing apparatus. Therefore, no notification is sent immediately to a printing apparatus when a setting value is selected for some setting items such as second setting value candidates that do not impose any setting restrictions on the selection of a setting value in other setting items among all setting items provided for making print-related setting. That is, in a case where the selection of a setting value is made for the above-mentioned some setting items, the selection is retained and thereafter notified to the printing apparatus as a batch notification at the time when triggered by instructions for sending a notification. Therefore, it is possible to reduce the amount of data that is sent via a network at the time of print setting. In addition thereto, it is further possible to shorten data processing time taken at a client side. Thus, a user does not experience a long wait due to data processing delay.

In the print setting method according to the invention, the number of the second setting value candidates may be increased or decreased in accordance with the first setting value. In the first notifying step, information related to the second setting value that is retained at the retaining section may also be notified.

In the print setting method according to the invention, it is preferable that the instructing section should have a plurality of instructing devices and that the retaining section should be provided so as to correspond to each of the instructing devices.

According to the invention, since the retaining section is provided so as to correspond to each of the instructing devices, it is possible to define the content of instructions for each of the instructing devices.

In the print setting method according to the invention, a next information screen that is to be displayed subsequently may be a confirmation screen for applying at least one of the first setting value and the second setting value to the printing apparatus. The first setting item may be either one or both of setting of a printing paper type and setting of a printing paper size. The second setting item may be either one or both of setting of a printing paper feed method and setting of print quality. In a print setting means according to the invention, the information screen may be described in an HTML format.

In order to provide a solution to the problem described above, a print setting apparatus according to the invention is characterized by including: a connecting section that establishes a connection to a network; a displaying section that displays an information screen that is sent from a printing apparatus via the connecting section; a first print setting selecting section that selects a first setting value out of a plurality of first setting value candidates related to printing; a second print setting selecting section that selects a second setting value out of second setting value candidates related to printing, the second setting value candidates being different from the first setting value candidates, the second setting value candidates being listed depending on the first setting value; a first notifying section that notifies information related to the first setting value and a request for updating the information screen to the printing apparatus via the connecting section at each time of selection made by the first print setting selecting section; a retaining section that retains information related to the second setting value on the information screen in an invisible state at each time of selection made by the second print setting selecting section; an instructing section that instructs that a notification of information that is different from information indicated by the first setting value candidates and the second setting value candidates should be sent to the printing apparatus; and a second notifying section that notifies, in response to instructions given by the instructing section, information related to the second setting value that is retained at the retaining section and a request for transition to a next information screen that is to be displayed subsequently to the printing apparatus via the connecting section.

According to the invention, in a case where a first setting value is selected out of a plurality of first setting value candidates provided for making print-related setting, information related to the first setting value and a request for updating an information screen are notified at each time of selection thereof. On the other hand, in a case where a second setting value is selected out of second setting value candidates related to printing by a second print setting selecting section, where the second setting value candidates are different from the first setting value candidates and are listed depending on the first setting value, information on the selected second setting value is retained. Then, information related to the second setting value and a request for transition to a next information screen that is to be displayed subsequently are notified to a printing apparatus upon reception of instructions for sending a notification to the printing apparatus. Therefore, no notification is sent immediately to a printing apparatus when a setting value is selected for some setting items such as second setting value candidates that do not impose any setting restrictions on the selection of a setting value in other setting items among all setting items provided for making print-related setting. That is, in a case where the selection of a setting value is made for the above-mentioned some setting items, the selection is retained and thereafter notified to the printing apparatus as a batch notification at the time when triggered by instructions for sending a notification. Therefore, it is possible to reduce the amount of data that is sent via a network at the time of print setting. In addition thereto, it is further possible to shorten data processing time taken at a client side. Thus, a user does not experience a long wait due to data processing delay.

In order to provide a solution to the problem described above, a printing apparatus according to the invention is characterized by including: a connecting section that establishes a connection to a network; an information screen creating section that creates an information screen that has at least one first setting item for making print-related setting, the above-mentioned at least one first setting item having a plurality of setting value candidates, and further has at least one second setting item for making print-related setting that is different from that of the above-mentioned at least one first setting item; an information screen transmitting section that transmits the information screen to a print setting apparatus via the connecting section; a first receiving section that receives a first information related to a setting value of the first setting item and a request for updating the information screen from the print setting apparatus via the connecting section; and a second receiving section that receives a second information related to a setting value of the second setting item and a request for transition to a next information screen that is to be displayed subsequently from the print setting apparatus via the connecting section, wherein the information screen creating section creates a update information screen that lists setting value candidates of the second setting item on the basis of the first information in a case where the first receiving section receives the request for updating whereas the information screen creating section creates the next information screen that is to be displayed subsequently on the basis of the second information in a case where the second receiving section receives the request for transition, and the information screen transmitting section transmits the update information screen in response to the updating request, which has been received by the first receiving section, whereas the information screen transmitting section transmits the next information screen that is to be displayed subsequently in response to the transition request, which has been received by the second receiving section.

### BRIEF DESCRIPTION OF THE DRAWINGS

FIG. 1 is a block diagram that illustrates an example of the configuration of a printing apparatus and a client, which are connected to each other so as to enable two-way communication therebetween via a network.

FIG. 2 is a block diagram that illustrates the functional configuration of a print setting means according to an embodiment of the invention.

FIG. 3 is a timing chart that illustrates the flow of information between a Web browser and a printing apparatus, which is exchanged when a user makes the print setting of the printing apparatus.

FIG. 4 is a diagram that illustrates a print setting page that is displayed on a Web browser.

FIG. 5 is a diagram that illustrates a print setting window that is displayed on a Web browser.

### EXPLANATION OF PREFERRED EMBODIMENTS

With reference to the accompanying drawings, embodiments of the present invention are described below.

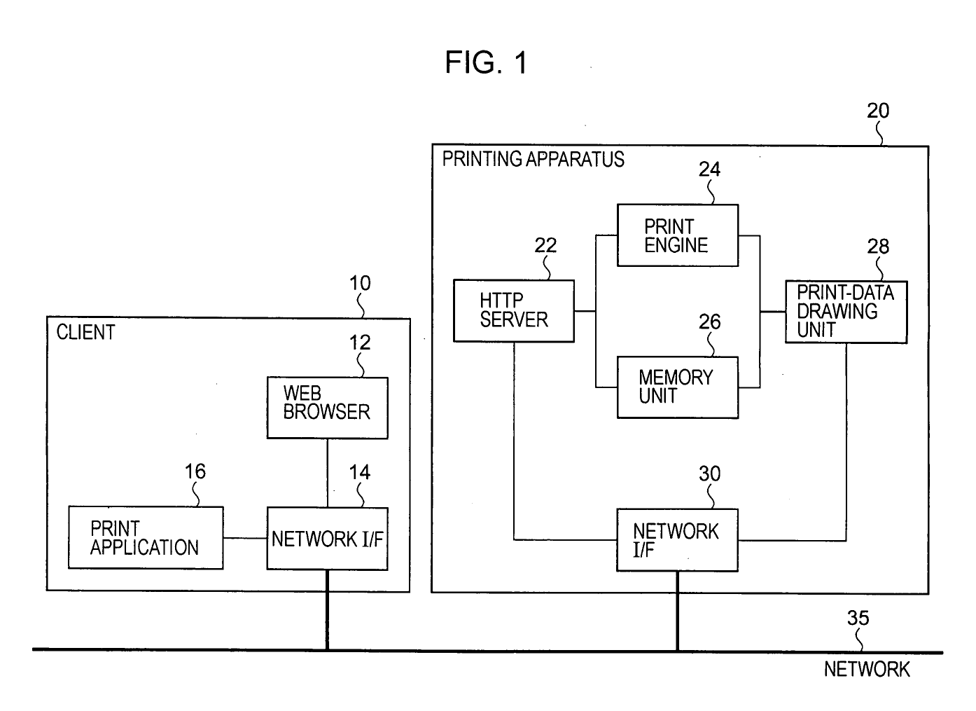

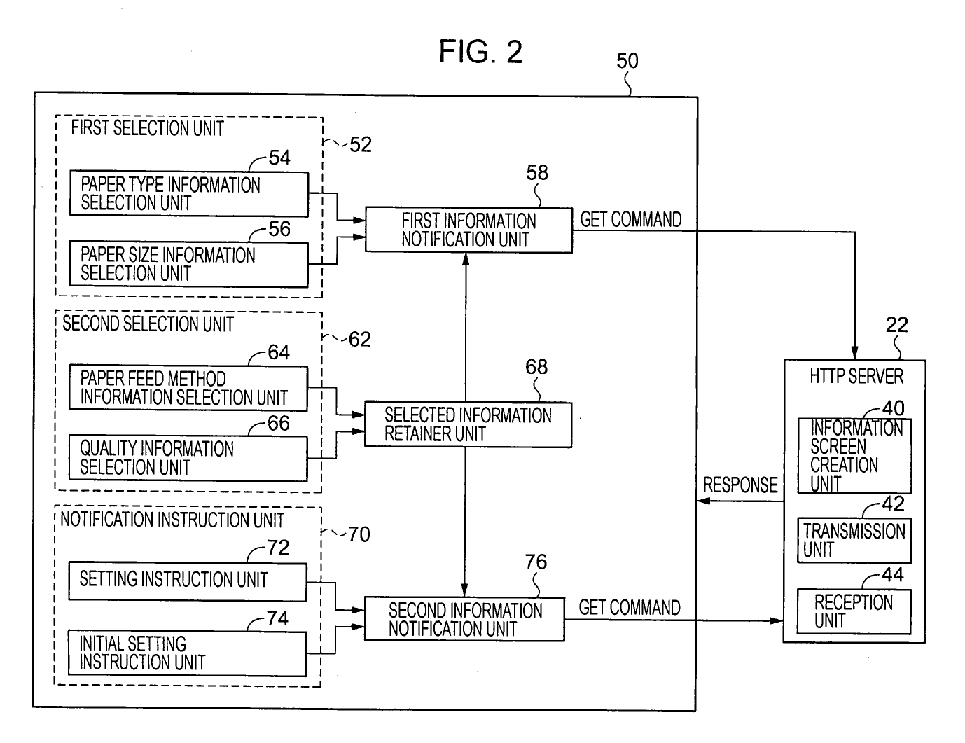

FIG. 1 is a block diagram that illustrates an example of the configuration of a printing apparatus 20 and a client 10 according to the present embodiment of the invention, which are connected to each other so as to enable two-way communication therebetween via a network 35. The client 10 includes a Web browser 12, a network I/F (interface) 14, and a print application 16. On the other hand, the printing apparatus 20 includes an HTTP (Hypertext Transfer Protocol) server 22, a print engine 24, a memory unit 26, a print-data drawing unit 28, and a network I/F 30. In such a configuration, the client 10 sends print data from its print application 16 to the printing apparatus 20. Upon reception of the print data from the client 10, the printing apparatus 20 can perform printing on a sheet of printing paper or the like on the basis of the received print data. The client 10 requests the printing apparatus 20 to send a print setting means 50 (refer to FIG. 2), which is used for making print-related setting, to the client 10. In response to the request, the HTTP server 22 of the printing apparatus 20 transmits data of an information screen that includes the print setting means 50 (FIG. 2) to the client 10. Upon reception of the data, the client 10 displays the information screen that is indicated by the received data on the Web browser 12 thereof. In addition thereto, the client 10 is capable of making, by using the print setting means 50 (FIG. 2) contained in the information screen, a variety of settings that is related to printing performed at the printing apparatus 20. A more detailed explanation of the print setting means 50 (FIG. 2) will be given later.

As an example of the client 10, it is possible to take a personal computer. The personal computer is provided with a CPU (Central Processing Unit), a RAM (Random Access Memory), a ROM (Read Only Memory), a storage device, and the like, as its hardware, which are not shown in the drawing. A software OS (Operating System) such as Microsoft Windows (registered trademark) or the like controls a variety of functions of the personal computer. The print application 16 runs on Windows (registered trademark) so as to create a print image. A printer driver (not shown in the drawing) that is installed on the PC converts the created print image into print data that is described in a page description language. The converted print data is sent via the network I/F 14 to the printing apparatus 20, which is connected to the network 35. The Web browser 12 is software that is capable of reading a hypertext, which is described in an HTML (Hypertext Markup Language), and displaying thereof. It is possible to take Microsoft Internet Explorer (registered trademark), which runs on Windows (registered trademark), as an example of the Web browser 12. Although it is assumed in the present embodiment of the invention that Windows (registered trademark) is adopted as its operating system, the operating system of the invention should be in no case understood to be limited to Windows (registered trademark). That is, any alternative OS other than Windows (registered trademark) may be adopted. In addition thereto, the client 10 is not restricted to a personal computer. Digital information equipment that can be connected to a network, for example, a digital television, may be adopted as the client 10.

As an example of the printing apparatus 20, it is possible to take an ink-jet printer that performs printing on a sheet of paper by using an ink-jet printing method. The ink-jet printer is provided with a CPU, a RAM, a ROM, a memory card controller, a print head, a paper-feed mechanical unit and the like as its hardware. Note that these hardware components are not illustrated in the drawing. The print data that has been sent from the client 10 to the printing apparatus 20 via the network 35 is forwarded to the print-data drawing unit 28 via the network I/F 30. The print-data drawing unit 28 creates bit image data by drawing the received print data on the memory of the memory unit 26. The print engine 24 prints the created bit image data out on a sheet of paper or the like so as to create a printed matter. The HTTP server 22 returns, in an HTTP protocol, a hypertext that is described in HTML in response to an external request command given thereto such as a GET command. Although a color ink-jet printer is taken as an example of the printing apparatus 20 according to the present embodiment of the invention described herein, the invention should be in no case understood to be limited thereto. For example, a printer that is dedicated to monochrome printing may be used as the printing apparatus 20. In addition, the printing scheme is not limited to the ink-jet printing. Any other printing scheme such as laser printing, thermal printing, dot impact printing, or the like, may be adopted. Moreover, the network 35 may be configured as a wired network such as IEEE 802.3, or as a wireless network such as IEEE 802.11b/g/a.

FIG. 2 is a block diagram that illustrates the functional configuration of the print setting means 50 according to the present embodiment of the invention. The print setting means 50 is contained in an information screen, which is displayed on the Web browser 12, as one component thereof. The print setting means 50 has a first selection unit 52, a second selection unit 62, a first information notification unit 58, a selected information retainer unit 68, a notification instruction unit 70, and a second information notification unit 76. On the other hand, the HTTP server 22 has an information screen creation unit 40, a transmission unit 42, and a reception unit 44.

The first selection unit 52 selects a first setting value out of a plurality of setting value candidates of at least one first setting item, which is provided for making print-related setting. In the present embodiment of the invention, the first selection unit 52 has, as the first setting item, a paper type information selection unit 54 and a paper size information selection unit 56. With such a configuration, at the first selection unit 52, the selection of a setting value related to a paper type and/or a paper size is made. In the present embodiment of the invention, as a result of the selection of a paper type, some restrictions are imposed on setting choices available for a paper size, a paper-feed method, and print quality. For example, it is assumed herein that a “postcard” is selected as the paper type. In such a case, the paper size thereof is uniquely determined as a “postcard” size without any other alternative choices. In addition thereto, the paper-feed direction thereof is also uniquely determined as “rear” feeding without any other alternative choices. As for the print quality thereof, a user can select either an “ordinary quality” mode or a “high quality” mode. In like manner, as a result of the selection of a paper size, some restrictions are imposed on setting choices available for a paper type, a paper-feed method, and print quality.

The second selection unit 62 selects a second setting value out of a plurality of setting value candidates of at least one second setting item, which is provided for making print-related setting that is different from that of the above-mentioned at least one first setting item, where the plurality of setting value candidates of the above-mentioned at least one second setting item is restricted by the first setting value. In the present embodiment of the invention, the second selection unit 62 has, as the second setting item, a paper feed method information selection unit 64 and a quality information selection unit 66. With such a configuration, at the second selection unit 62, the selection of a setting value related to a paper feed method and/or print quality is made. It should be noted that the setting value of the paper type and/or the paper size remains intact as a result of the selection of a setting value related to the paper feed method and/or the print quality.

The paper type information selection unit 54 selects, among a plurality of types of printing paper on which the printing apparatus 20 can perform printing, a certain type of printing paper that is set at the printing apparatus 20. The paper size information selection unit 56 selects, among a plurality of sizes of printing paper on which the printing apparatus 20 can perform printing, a certain size of printing paper that is set at the printing apparatus 20. The paper feed method information selection unit 64 selects, among a plurality of paper feed methods that are available for feeding printing paper to the printing apparatus 20, a certain paper feed method that is set at the printing apparatus 20. The quality information selection unit 66 selects, among a plurality of print qualities that constitutes choices available for determining the quality of printing performed by the printing apparatus 20, a certain print quality that is set at the printing apparatus 20.

The first information notification unit 58 notifies information related to the first setting value and further notifies a request for updating the information screen to the HTTP server 22 of the printing apparatus 20 at each time of selection made by the first selection unit 52. In addition, the first information notification unit 58 may further notify information related to the second setting value that is retained at the selected information retainer unit 68, where such an additional configuration is optional. It should be noted that such a notification is sent in the form of a command that orders the recipient of the notification (i.e., the HTTP server 22) to send a reply in response to the notification to the issuer of the notification (i.e., the print setting means 50) without delay. A GET command issued to the HTTP server 22 is an example of such a command. One setting item whose setting value is selected by the first selection unit 52 and another setting item whose setting value is selected by the first selection unit 52 are related to each other. Therefore, for example, a GET command orders the information screen creation unit 40 of the HTTP server 22 to update, in accordance with the selection of a certain type of printing paper made by the paper type information selection unit 54, an information screen that reflects paper size information, paper feed method information, and print quality information that are associated with the selected type of printing paper.

The reception unit 44 of the HTTP server 22 receives first information on the setting value of the first setting item and further receives the request for updating the information screen via the network I/F 30. Then, the reception unit 44 forwards the received request for updating the information screen to the information screen creation unit 40. The information screen creation unit 40 creates an information screen that has at least one first setting item for making print-related setting, where the above-mentioned at least one first setting item has a plurality of setting value candidates, and further has at least one second setting item for making print-related setting that is different from that of the above-mentioned at least one first setting item. The transmission unit 42 sends hypertext data of the created information screen to the Web browser 12. As a result thereof, the information screen displayed on the Web browser 12 is updated. In the updated information screen, the number of setting values that constitute available choices in at least one of the setting items of the paper size, the paper feed method, and the print quality has been increased or decreased in accordance with the selected printing paper type. Since information on the setting value that is currently set in the printing apparatus 20 can be stored for each individual client 10 by using, for example, Cookie, the HTTP server 22 is capable of storing information on the notified setting value, by overwriting it on the Cookie corresponding to the client 10, as the latest setting value information.

The selected information retainer unit 68 retains the setting value that is selected by the second selection unit 62 on an information screen in an invisible state at each time of selection made by the second selection unit 62. In the present embodiment of the invention, property setting is made on an entry form, which constitutes a component of an information screen, so as to conceal the display of inputted information. By this means, the above-mentioned invisible state is realized.

The notification instruction unit 70 has a function to order that information should be notified to the printing apparatus 20. In the present embodiment of the invention, the notification instruction unit 70 has a setting instruction unit 72 and an initial setting instruction unit 74.

The setting instruction unit 72 orders the printing apparatus 20 to validate the setting value selected by means of the print setting means 50. The information instructed thereby is sent to the second information notification unit 76. On the other hand, the initial setting instruction unit 74 orders the printing apparatus 20 to be set into a predetermined initial setting value. The information instructed thereby is sent to the second information notification unit 76.

In response to the instructions given by the notification instruction unit 70, the second information notification unit 76 notifies information on the second setting value that is retained at the selected information retainer unit 68 and further notifies a request for transition to the next information screen that is to be displayed subsequent to the current information screen to the HTTP server 22 of the printing apparatus 20. The notification sent by the second information notification unit 76 takes the form of a GET command issued to the HTTP server 22, as in the case of a notification sent by the first information notification unit 58. The reception unit 44 of the HTTP server 22 receives second information on the setting value of the second setting item and further receives the request for transition to the next information screen that is to be displayed subsequent to the current information screen via the network I/F 30.

If the notification received from the second information notification unit 76 is based on instructions given by the setting instruction unit 72, the HTTP server 22 follows the notified GET command and sends, to the Web browser 12, hypertext data of the next information screen that is to be displayed subsequent to the current information screen. As a result thereof, the next information screen is displayed on the Web browser 12. In addition thereto, the received information on the setting value selected by the second selection unit 62 may be overwritten on the Cookie so as to set the setting value that is written in the Cookie as the setting value of the printing apparatus 20 itself.

On the other hand, if the notification received from the second information notification unit 76 is based on instructions given by the initial setting instruction unit 74, the HTTP server 22 follows the notified GET command and sends, to the Web browser 12, hypertext data of the next information screen that is to be displayed subsequent to the current information screen. As a result thereof, the next information screen is displayed on the Web browser 12. In addition thereto, the printing apparatus 20 sets the initial setting value that has been determined in advance and stored in the printing apparatus 20 itself as the setting value of its own; and in addition, the printing apparatus 20 overwrites it on the Cookie. In the present embodiment of the invention, the print setting means 50 is embodied as a combination of the aforementioned hardware components of the client 10 and software components such as the Web browser 12, which co-operate with each other. Notwithstanding the foregoing, it is possible to conceive another embodiment such as a print setting apparatus that is further provided with, in addition to these functional components, the network I/F 14 that is provided for making a connection to a network.

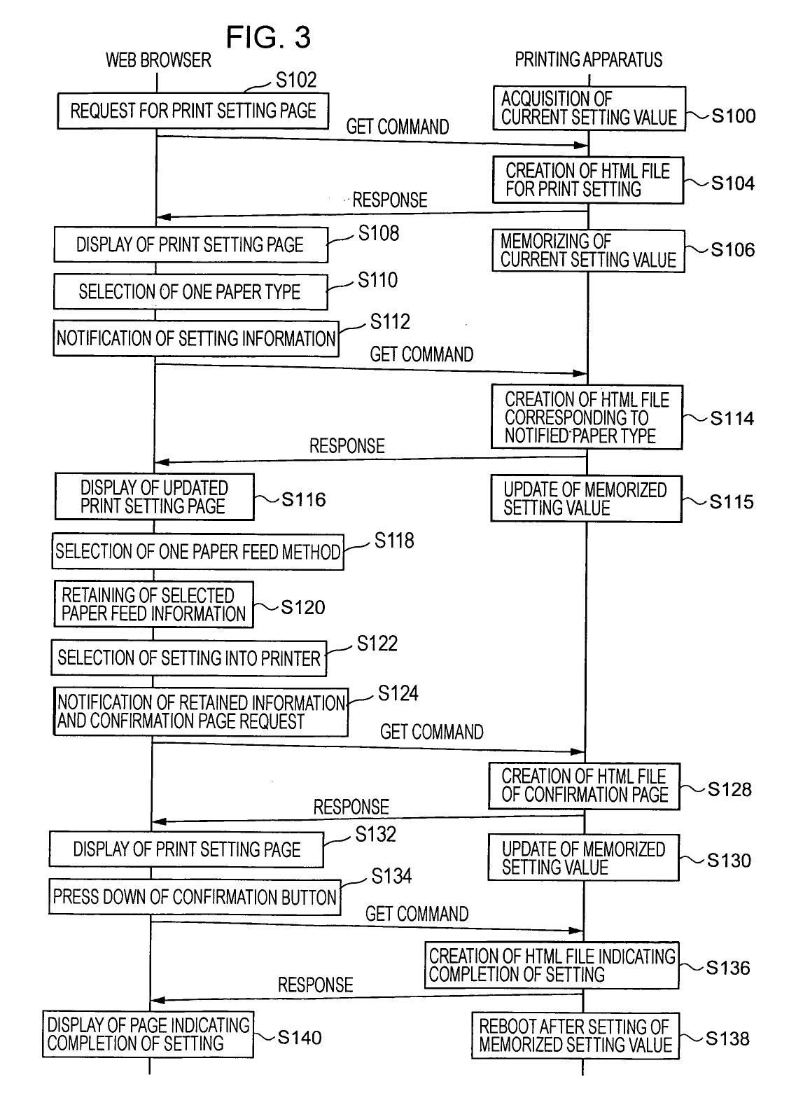

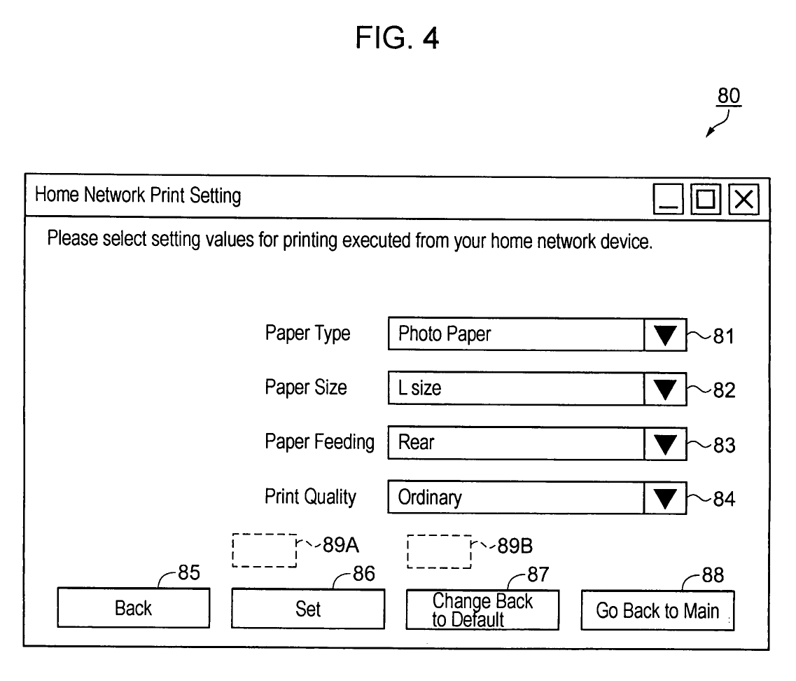

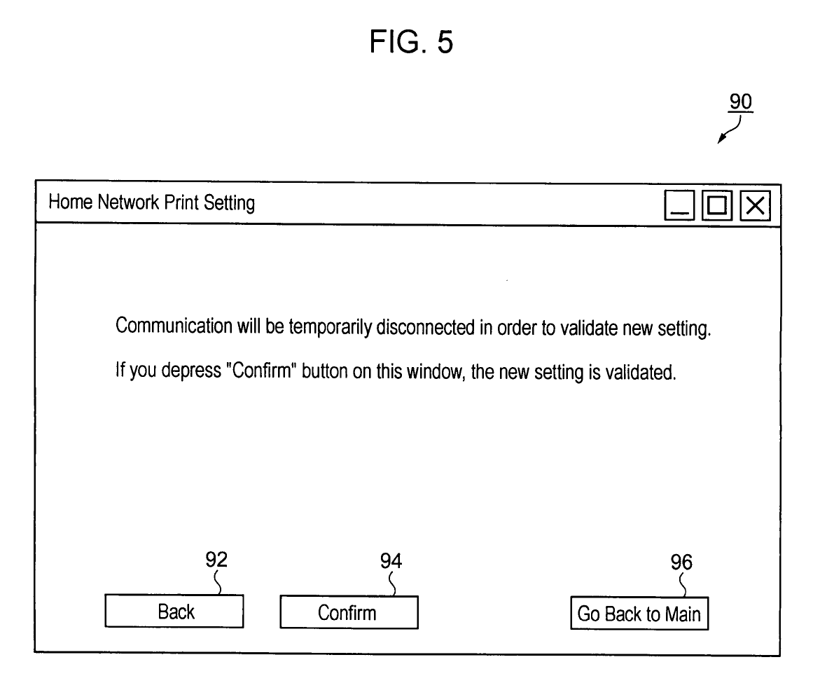

FIG. 3 is a timing chart that illustrates the flow of information between the Web browser 12 and the printing apparatus 20, which is exchanged when a user makes the print setting of the printing apparatus 20. Each of FIGS. 4 and 5 is a diagram that illustrates a print setting window that is displayed on the Web browser 12. In the following explanation, these drawings are also referred to in addition to FIG. 3.

Upon activation of the printing apparatus 20, information on the setting value that is currently set in the printing apparatus 20 is acquired from the memory unit 26 thereof in a step S100. After the launching of the Web browser 12, a GET command that requests for a print setting page is notified to the HTTP server 22 in a step S102 as a result of the designation of the URL (Uniform Resource Locator) of the HTTP server 22.

Next, in a step S104, the HTTP server 22 creates hypertext data of a print setting page and sends the created hypertext data to the Web browser 12 in response to the received GET command. Then, in a step S106, the HTTP server 22 writes information on the currently set value into the Cookie.

Next, in a step S108, upon reception of the hypertext data from the HTTP server 22, the Web browser 12 displays the print setting page that is represented by the received hypertext. FIG. 4 illustrates a print setting page 80 that is displayed on the Web browser 12. Regarding the paper type, the paper size, the paper feed method, and the print quality, a user makes selection among setting values that constitute available choices offered in the corresponding list boxes (81-84). Specifically, the paper type list box 81 corresponds to the paper type information selection unit 54, whereas the paper size list box 82 corresponds to the paper size information selection unit 56. The paper feed method list box 83 corresponds to the paper feed method information selection unit 64, whereas the print quality list box 84 corresponds to the quality information selection unit 66. Each of these setting items has its initial value. In a case where a user does not make any selection thereon, the initial value is used as a setting value. Although the list boxes (81-84) are taken as a means for selecting setting values herein, the selecting means of the invention is not limited thereto. For example, selection may be made by means of radio buttons in place of these list boxes.

A “Set” button 86 is an instructing device that is provided for operating the setting instruction unit 72. A “Change Back to Default” button 87 is an instructing device that is provided for operating the initial setting instruction unit 74. It should be noted that each of the “Set” button 86 and the “Change Back to Default” button 87 has non-display areas (89A and 89B) where data is retained in an invisible state. A “Back” button 85 is used for giving instructions to the HTTP server 22 so that the hypertext of the preceding page (which is not shown in the drawing) that was shown immediately before the print setting page 80 is displayed. On the other hand, a “Go Back to Main” button 88 is used for giving instructions to the HTTP server 22 so that the hypertext of the first page of a series of print setting pages (which is not shown in the drawing) is displayed.

Next, in a step S110, the user selects a new choice that is not the same as current one among a plurality of available choices shown in the paper type list box 81. Thereafter, in a step S112, information on the setting value that is selected in each of the list boxes (81-84) and a request for updating the print setting page 80 so as to reflect the selection made on the paper type are notified to the HTTP server 22 in the form of a GET command.

Next, in a step S114, the HTTP server 22 creates hypertext data of the updated print setting page 80 that reflects the selection made on the paper type and then sends the created hypertext data to the Web browser 12 in response to the received GET command. Then, in a step S115, the HTTP server 22 overwrites the information related to the selected paper type on the Cookie for updating thereof. Next, in a step S116, upon reception of the updated hypertext data from the HTTP server 22, the Web browser 12 displays the print setting page 80 that is represented by the received hypertext.

Next, in a step S118, the user selects a new choice that is not the same as current one among a plurality of available choices shown in the paper feed method list box 83. Then, in a step S120, information on the selected paper feed method is retained in each of the non-display areas (89A and 89B).

Next, in a step S122, the user depresses the “Set” button 86. Thereafter, in a step S124, a GET command that requests the HTTP server 22 to return a print setting confirmation page is notified to the printing apparatus 20 together with information retained in one of the non-display areas, 89A. If the “Change Back to Default” button 87 is pressed down in place of the “Set” button 86, the GET command is notified to the printing apparatus 20 together with information retained in the other of the non-display areas, 89B, which is a procedure similar to that executed in the above-described case where the “Set” button 86 is depressed.

Next, in a step S128, the HTTP server 22 creates hypertext data of a print setting confirmation page and sends the created hypertext data to the Web browser 12 in response to the received GET command. The HTTP server 22 may allow a message box showing the occurrence of an error to be displayed at the client 10 and then terminate the series of processing if, as a result of comparison made between the content of user-selected print setting and the current setting value written in the Cookie, the HTTP server 22 finds that they are in agreement with each other.

Thereafter, in a step S130, the HTTP server 22 overwrites the information that is retained in the above-mentioned one of the non-display areas, that is, 89A, which was notified in the GET command, in the Cookie so as to effect an updating thereof. Specifically, the HTTP server 22 overwrites the information related to the paper feed method into the Cookie for updating thereof. If the “Change Back to Default” button 87 was depressed in the step S122, the HTTP server 22 may overwrite the predetermined initial setting value information in the Cookie for updating thereof.

Next, in a step S132, upon reception of the hypertext data from the HTTP server 22, the Web browser 12 displays the print setting confirmation page that is represented by the received hypertext. FIG. 5 shows a print setting confirmation page 90 that is displayed on the Web browser 12. A “Back” button 92, a “Confirm” button 94, and a “Go Back to Main” button 96 are displayed at the bottom region of the print setting confirmation page 90 so as to allow the user to make selection therebetween. If the “Confirm” button 94 is depressed, the setting choices that are made in the print setting page 80 are set at the printing apparatus 20. The “Back” button 92 is used for giving instructions to the HTTP server 22 so that the hypertext of the preceding page that was shown immediately before the print setting confirmation page 90, that is, the print setting page 80, is displayed. On the other hand, the “Go Back to Main” button 96 is used for giving instructions to the HTTP server 22 so that the hypertext of the first page of a series of print setting pages (which is not shown in the drawing) is displayed.

Next, in a step S134, the user depresses the “Confirm” button 94. When the “Confirm” button 94 is pressed down, a GET command that requests for a page indicating the completion of print setting is notified to the HTTP server 22.

Next, in a step S136, the HTTP server 22 creates hypertext data of a print setting completion page (which is not shown in the drawing) and sends the created hypertext data to the Web browser 12 in response to the received GET command. In addition thereto, in a step S138, the printing apparatus 20 reboots itself after setting the setting value information that is written in the Cookie into the printing apparatus 20 itself and then ends the series of processing. If the “Change Back to Default” button 87 was depressed in the step S122, the printing apparatus 20 sets the predetermined initial setting value into the printing apparatus 20 itself and subsequently reboots itself so as to terminate the series of processing in the step S138.

On the other hand, in a step S140, upon reception of the hypertext data from the HTTP server 22, the Web browser 12 displays the print setting completion page (which is not shown in the drawing) that is represented by the received hypertext. Then, the user presses down a confirmation button that is provided on the print setting completion page so as to terminate the series of processing.

The exemplary embodiments of the invention described above offer the following advantageous effects.

Print setting items are sorted into a group of setting items for which the content of setting is immediately notified to an HTTP server at each time of the execution of setting and another group of setting items for which the content of setting is retained and thus not immediately notified to the HTTP server at the instant of the execution thereof. With such a configuration, it is possible to minimize communication between a client and the HTTP server. Thus, the conventional waiting time is significantly reduced for the benefit of a user.

In addition, since the setting value of the latter group of setting items for which the content of setting is retained and thus not immediately notified to the HTTP server at the moment of the setting execution is retained in such a manner that it is associated with buttons that trigger a page transition with a non-display property, the retained setting value is notified to the HTTP server when the button is depressed. Therefore, user setting is notified to the HTTP server without fault.

Although the present invention is explained above while discussing exemplary embodiments thereof with reference to the accompanying drawings, it should be noted that, in no case, these explanatory embodiments are interpreted to limit the scope of the invention. For example, it is possible to modify the foregoing exemplary embodiments of the invention into variation examples given below.

(1) Information that is written into the non-display areas (89A and 89B) is not limited to one pertaining to the paper feed method and/or the print quality. Any other information may be written therein so as to make up a database.

1. A print setting method that displays an information screen that is sent from a printing apparatus connected to a network so as to make the setting of the printing apparatus, the print setting method comprising:
a first print setting selecting step of selecting a first setting value out of a plurality of first setting value candidates related to printing;
a second print setting selecting step of selecting a second setting value out of second setting value candidates related to printing, the second setting value candidates being different from the first setting value candidates, the second setting value candidates being listed depending on the first setting value;
a first notifying step of notifying information related to the first setting value and a request for updating the information screen to the printing apparatus at each time of selection of the first setting value;
a retaining section that retains information related to the second setting value on the information screen in an invisible state at each time of selection of the second setting value;
an instructing section that instructs that a notification of information that is different from information indicated by the first setting value candidates and the second setting value candidates should be sent to the printing apparatus; and
a second notifying step of notifying, in response to instructions given by the instructing section, information related to the second setting value that is retained at the retaining section and a request for transition to a next information screen that is to be displayed subsequently.

2. The print setting method according to claim 1, wherein, in the first notifying step, information related to the second setting value that is retained at the retaining section is also notified.

3. The print setting method according to claim 1, wherein the instructing section has a plurality of instructing devices; and the retaining section is provided so as to correspond to each of the instructing devices.

4. The print setting method according to claim 1, wherein the next information screen that is to be displayed subsequently is a confirmation screen for applying at least one of the first setting value and the second setting value to the printing apparatus.

5. The print setting method according to claim 1, wherein the number of setting candidates of the second setting item is increased or decreased in accordance with the first setting value.

6. The print setting method according to claim 1, wherein the first setting item is either one or both of setting of a printing paper type and setting of a printing paper size.

7. The print setting method according to claim 1, wherein the second setting item is either one or both of setting of a printing paper feed method and setting of print quality.

8. A print setting apparatus comprising:
a connecting section that establishes a connection to a network;
a displaying section that displays an information screen that is sent from a printing apparatus via the connecting section;
a first print setting selecting section that selects a first setting value out of a plurality of first setting value candidates related to printing;
a second print setting selecting section that selects a second setting value out of second setting value candidates related to printing, the second setting value candidates being different from the first setting value candidates, the second setting value candidates being listed depending on the first setting value;
a first notifying section that notifies information related to the first setting value and a request for updating the information screen to the printing apparatus via the connecting section at each time of selection made by the first print setting selecting section;
a retaining section that retains information related to the second setting value on the information screen in an invisible state at each time of selection made by the second print setting selecting section;
an instructing section that instructs that a notification of information that is different from information indicated by the first setting value candidates and the second setting value candidates should be sent to the printing apparatus; and
a second notifying section that notifies, in response to instructions given by the instructing section, information related to the second setting value that is retained at the retaining section and a request for transition to a next information screen that is to be displayed subsequently to the printing apparatus via the connecting section.

9. A printing apparatus comprising:
a connecting section that establishes a connection to a network;
an information screen creating section that creates an information screen that has at least one first setting item for making print-related setting, the above-mentioned at least one first setting item having a plurality of setting value candidates, and further has at least one second setting item for making print-related setting that is different from that of the above-mentioned at least one first setting item;
an information screen transmitting section that transmits the information screen to a print setting apparatus via the connecting section;
a first receiving section that receives a first information related to a setting value of the first setting item and a request for updating the information screen from the print setting apparatus via the connecting section; and
a second receiving section that receives a second information related to a setting value of the second setting item and a request for transition to a next information screen that is to be displayed subsequently from the print setting apparatus via the connecting section,
wherein the information screen creating section creates a update information screen that lists setting value candidates of the second setting item on the basis of the first information in a case where the first receiving section receives the request for updating whereas the information screen creating section creates the next information screen that is to be displayed subsequently on the basis of the second information in a case where the second receiving section receives the request for transition, and
the information screen transmitting section transmits the update information screen in response to the updating request, which has been received by the first receiving section, whereas the information screen transmitting section transmits the next information screen that is to be displayed subsequently in response to the transition request, which has been received by the second receiving section.
